(19) United States
(12) Patent Application Publication
(10) Pub. No.: US 2008/0205319 A1
(43) Pub. Date: Aug. 28, 2008

(54) METHOD AND APPARATUS FOR MANAGING INFORMATION OF TERMINAL EXITING IDLE MODE

(75) Inventors: Jianjun WU, Shenzhen (CN); Yong XIE, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/110,605

(22) Filed: Apr. 28, 2008

Related U.S. Application Data
(63) Continuation of application No. PCT/CN2006/002868, filed on Oct. 26, 2006.

(30) Foreign Application Priority Data
Oct. 28, 2005 (CN) 200510118942.0

(51) Int. Cl. H04Q 7/20; H04Q 7/38

(52) U.S. Cl. 370/311; 455/574; 455/458

(57) ABSTRACT

The present invention provides a method and an apparatus for managing the information of a terminal exiting idle mode mainly includes: deleting relevant information of the terminal retained in a paging controller and a location register of a wireless communication system when the terminal has exited idle mode. With the present invention, the relevant information aiming at the terminal retained in the PC and the LR is deleted after the terminal has exited idle mode so as to utilize the resources of the PC and the LR effectively and improve the utilization rate of air interface emission resource of the PC.

### CROSS-REFERENCE TO RELATED APPLICATIONS

This application is a continuation of International Patent Application No. PCT/CN2006/002868, filed Oct. 26, 2006, which claims priority to Chinese Patent Application No. 200510118942.0, filed Oct. 28, 2005, entitled “Method and Apparatus for Managing Information of Terminal Exiting Idle Mode,” both of which are hereby incorporated by reference in their entirety.

### FIELD OF THE INVENTION

The present invention relates to the communication field, and more particularly to an implementation solution for managing the information of a terminal exiting idle mode.

### BACKGROUND OF THE INVENTION

Idle mode, defined by Institute of Electronics and Electrical Engineers 802.16 mobile (IEEE 802.16e) standard, is a kind of terminal working mode in the mobile broadband wireless access system. Under this mode, a Mobile Station (MS) roams in a preset area, receives downlink broadcast service message transmitted by a Base Station (BS) after an interval of period. The BS informs the MS that whether there is downlink service to transmit according to the broadcast service message.

In the mobile broadband wireless access system, many BSs may form a Paging Group. The Paging Group is adapted to constitute a continuous area. When the MS moves across small segments of the area, the MS does not need perform the operation flow of switching, location updating, etc. Therefore the power of the MS and the air interface resource can be saved. The MS may determine whether there is a downlink service to be sent to the MS by the downlink paging channel. The Paging Group needs two characteristics at the same time as follows.

1. The Paging Group needs to be big enough to ensure that the majority of the MS may stay in the same Paging Group for a long time.

2. The Paging Group needs to be small enough to ensure an acceptable cost when a Paging Group pages an MS.

When the MS performs normal operations with a Serving Base Station (Serving BS), the MS can enter idle mode by sending a request message to the Serving BS. Meanwhile, the Serving BS may also send a message to initiatively request the MS to enter idle mode. No matter the MS initiatively sends a request message to enter idle mode, or the Serving BS initiatively sends a message to request the MS to enter idle mode, the MS needs to complete the process of deregistering and entering idle mode within pre-defined time.

In the Worldwide Interoperability for Microwave Access (WiMAX) system, a schematic diagram illustrating an MS paging reference model under idle mode is shown in FIG. 1. In the reference model, a Paging Controller (PC) is a network entity controlling the MS idle mode action. The network entity is a logic entity correlated with another logic entity authenticator in the existing WiMAX network frame. In addition, a Location Register (LR) is set for storing the MS status information, paging information, and relevant service flow information because the PC needs to initiate a paging message according to the paging group in which the MS is currently located. The LR is a logic entity which corresponds to a PC logic entity and both of the two logic entities can be implemented in the same physical network element.

In the paging reference model shown in FIG. 1, when an MS initiatively requests to enter idle mode to the BS1 being as the Serving BS, or the BS1 instructs the MS to enter idle mode, the MS firstly performs information interaction with the BS1. Then the BS 1 performs information interaction with a rear network element access service network gateway (ASN-GW) to inform the PC (which is realized in ASN-GW1) that the MS has entered idle mode. In the meantime, the status information, paging information and service flow information of the MS are stored in the corresponding LR.

The retained information needed for entering idle mode may be carried in the idle mode request information sent by the MS to the BS1. Similar information can also be carried in the idle mode request information returned from the BS1 to the MS to inform the MS of relevant information retained in the LR, and inform the MS of the PC identification (ID). In addition after the MS has entered idle mode, the corresponding R4 interface and R6 interface should be released. However, the R3 interface between the corresponding HA (Home Agent) and FA (Foreign Agent) should be retained.

Traditionally, a specific process for a terminal exiting idle mode, as shown in FIG. 2, includes the following steps.

Step 21: An MS initiates a process for exiting idle mode according to the real situation, e.g. being paged. The MS firstly sends a ranging request(RNG_REQ)message to a Serving BS. The PC ID of the PC where the MS is located is carried in the message for indicating that the terminal requires performing network re-entry from idle mode.

Step 22: After the Serving BS has received the RNG_REQ message, the Serving BS sends an MS information request (MS Info Request) message to a Serving ASN-GW. The MS Info Request message includes an MS ID (MS identifier which may be the MAC address of the MS), a BS ID, and a PC ID acquired from an RNG_REQ message.

Step 23: After receiving the MS Info Request message, the Serving ASN-GW confirms the ASN-GW in which the PC is located according to the PC ID carried in the MS Info Request message and sends the received MS Info Request message to the ASN-GW.

Step 24: After receiving the MS Info Request message, the ASN-GW where the PC is located fetches the relevant retained information of the MS in the LR and sends the MS Info Response message to the Serving ASN-GW. The MS Info Response message includes MS ID , an Anchor GW (anchor gateway, equal to the FA) ID, AK (n) and security context, MS idle Mode Retain Information, and MS information (MS Info) such as service flow identifiers (SFIDS), connection identifiers (CIDs), and quality of service (QoS) context.

Step 25: The Serving ASN-GW transfers the received MS Info Response message to the Serving BS. If the RNG_REQ message has been verified, the Serving BS verifies the validity of the received RNG_REQ message according to the key information in the information. When the verification is passed, the acquired MS relevant information is stored.

Step 26: The Serving BS starts to establish the data channel with the Serving ASN-GW. The Serving BS firstly sends a data path establishment request message to the Serving ASN-GW. The Data Path Establishment Request message includes an MS ID, an Anchor GW ID (e.g. IP address), and Downlink Service Flow Info (e.g. SFIDs, GRE keys, and QoS context).

Step 27: After receiving the Data Path Establishment Request message and acquiring the information of the Anchor ASN-GW(anchor ASN-GW playing the role of foreign agent), the Serving ASN-GW begins to establish the data path with the Anchor ASN-GW. The Serving ASN-GW also sends a Data Path Establishment Request message to the Anchor ASN-GW. The Data Path Establishment Request message includes an MS ID, Downlink Service Flow Info (e.g. SFIDs, GRE keys, and QoS context).

Step 28: The Anchor ASN-GW confirms the establishment of the data path with the Serving ASN-GW and sends a Data Path Establishment Response message to the Serving ASN-GW. The Data Path Establishment Response message includes an MS ID, and Uplink Service Flow Info (e.g. SFIDs, GRE keys, and QoS text).

Step 29: The Serving ASN-GW confirms the establishment of the data path with the Serving BS and sends a Data Path Establishment Response message to the Serving BS. The Data Path Establishment Response message includes an MS ID, and Uplink Service Flow Info (e.g. SFIDs, GRE keys, and QoS context).

Step 210: After receiving the Data Path Establishment Response message sent by the Serving ASN-GW, the Serving BS sends a ranging response (RNG_RSP) message which carries the retained MS relevant information according to the requirement of IEEE 802.16e.

Step 211: The MS completes the process of network re-entry according to IEEE 802.16e regulation according the received RNG-RSP message.

Step 212: After the MS has completed the process of network re-entry, the Serving BS sends a Data Path Establishment Acknowledgement message to the Serving ASN-GW for confirming the completion of the data path establishment between the Serving BS and the Serving ASN-GW.

Step 213: The Serving ASN-GW then sends a Data Path Establishment Acknowledgement message to the Anchor ASN-GW for confirming the completion of the data path establishment between the Serving ASN-GW and the ASN-GW.

It can be seen that in the process that a terminal exits idle mode, there isn't provided any corresponding processing mechanism in order to ensure that the PC and the LR deletes the retained MS relevant information after the terminal has exited idle mode. Therefore, there exists the following disadvantages in the process mentioned above.

1. The PC sends a mobile paging advertisement (MOB_PAG_ADV)message to its subordinate MS when the location updating interval of the MS arrives according to the definition of IEEE 802.16e because the PC does not delete the stored paging state machine message corresponding to the terminal. However, the MS has exited idle mode at that time. The MOB_PAG_ADV message is useless for the MS. The meaningless transmission of the message leads to a waste of the air interface resource. If the MS keeps staying under the PC after the MS has exited idle mode, how to deal with the received MOB_PAG_ADV message is not defined in the air interface protocol of IEEE 802.16e.

2. There is a large quantity of junk information in the PC and the LR because the PC and the LR does not delete the retained MS relevant information. The junk information may move to a new PC and a new LR when the terminal enters idle mode at the next time after the terminal has exited idle mode. A large quantity of junk information will be retained in the PC and the LR when the situation appears in a lot of terminals.

### SUMMARY OF THE INVENTION

The present invention provides a method and apparatus for managing the information of a terminal exiting idle mode to delete the relevant information aiming at the terminal retained in PC and LR after the terminal has exited idle mode.

The following technical solution achieves above object.

A method for managing information of a terminal exiting idle mode includes:

deleting relevant information of a terminal retained in a paging controller and a location register of a wireless communication system after the terminal has exited idle mode.

The method further includes:

deleting, by the paging controller and the location register, the relevant information of the terminal retained in the paging controller and the location register according to received indication information of requesting to delete the relevant information of the terminal retained in the paging controller and the location register, after the terminal has exited idle mode.

The method further includes:

sending, by a serving base station service node, an indication message to a base station service node where the paging controller providing service for the terminal is located after the terminal has exited idle mode

informing, by the base station service node where the paging controller is located, the paging controller to stop the paging state machine corresponding to the terminal, and the location register to delete the relevant information of the terminal retained in the location register after receiving the indication message.

The method further includes: after the paging controller has stopped the paging state machine corresponding to the terminal, not sending a paging message of requesting to perform periodicity location updating when a follow-up paging interval of the terminal arrives.

The method further includes:

requesting, by the serving base station, for a relevant key information from an authenticator via the serving base station service node; and verifying a received ranging request message after the serving base station has received the ranging request message sent by the terminal;

sending, by the serving base station, a terminal information request message carrying an idle mode exit indication to the serving base station service node after the verification for the ranging request message is passed; and

transferring, by the serving base station service node, the received terminal information request message to a base station service node where the paging controller providing service for the terminal is located; informing, by the serving base station service node, the paging controller to stop the paging state machine corresponding to the terminal; and informing the location register to delete the relevant information of the terminal retained in the location register.

The method further includes:

configuring and starting a timer in the paging controller whose duration is determined by the location updating time interval of the terminal, after the terminal has exited idle mode; and

stopping, by the paging controller, the paging state machine corresponding to the terminal; and informing, by the paging controller, the location register to delete the relevant information of the terminal retained in the location register when the location updating message of the terminal is not received after the timer is timeout.

An apparatus for managing information of a terminal exiting idle mode includes an idle mode exit determination unit and an information deletion operation unit.

The idle mode exit determination unit is adapted to determine whether the terminal has exited idle mode, and to trigger the information deletion operation unit after determining that the terminal has exited idle mode.

The information deletion operation unit is adapted to control the deletion of the relevant information of the terminal retained in the paging controller and the location register under the triggering of the idle mode exit determination unit.

The information deletion operation unit, set in the paging controller and the location register, is specifically adapted to stop the paging state machine corresponding to the terminal and delete the relevant information of the terminal retained in the paging controller and the location register according to the received indication information of requesting to delete the relevant information of the terminal retained in the paging controller and the location register after the terminal has exited idle mode.

The apparatus further includes a timer is configured and started in the paging controller after the terminal has exited idle mode; and adapted to trigger the information deletion operation unit when the location updating message of the terminal is not received after the timer is timeout.

It can be seen from above technical solution provided by the present invention that the PC and the LR deletes the information of a terminal retained in the PC and the LR according to the received message or their own timing judgment in or after the process of exiting idle mode by the terminal. Therefore, the resource of the PC and the LR can be effectively utilized to improve the utilization rate of the air interface emission resource of the PC.

### BRIEF DESCRIPTION OF THE DRAWINGS

FIG. 1 is a schematic diagram illustrating an MS paging reference model under idle mode according to the definition of WiMAX standard;

FIG. 2 is a specific processing flowchart illustrating a method for a terminal exiting idle mode;

FIG. 3 is a specific processing flowchart in accordance with an embodiment of the present invention;

FIG. 4 is a specific processing flowchart in accordance with an embodiment of the present invention;

FIG. 5 is a specific processing flowchart in accordance with an embodiment of the present invention; and

FIG. 6 is a schematic diagram illustrating the apparatus of the present invention.

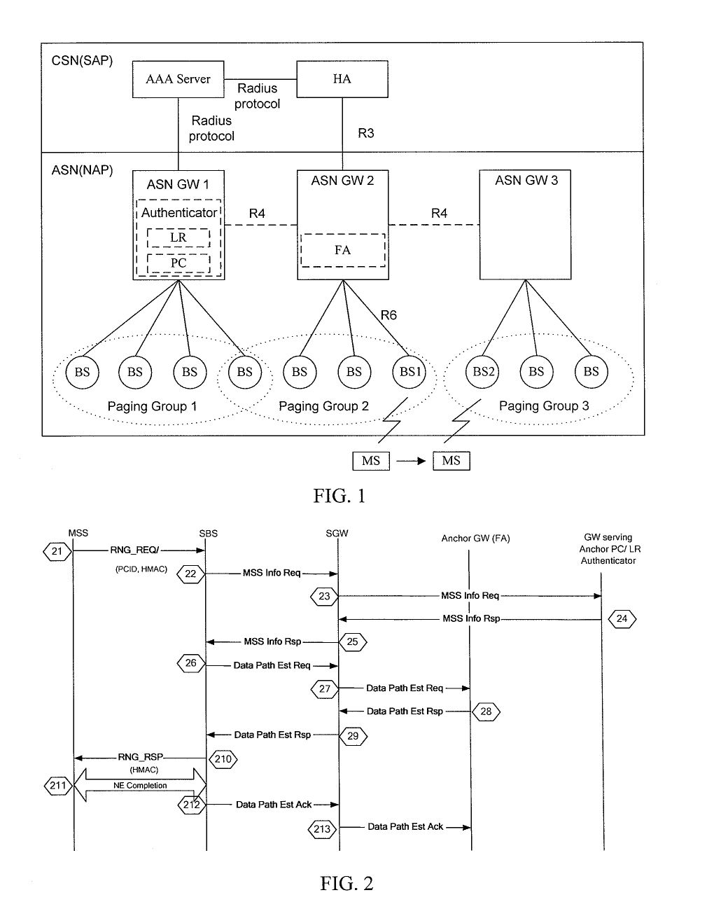

### DETAILED DESCRIPTION OF THE PREFERRED EMBODIMENTS

The embodiments of the present invention provides a technical solution for managing the information of a terminal exiting idle mode so that the PC and LR can delete the relevant information of the terminal retained in the PC and the LR according to the received message or their own timing determination when the terminal exits idle mode.

The method of the present invention is improved based on the processing flow shown in FIG. 2. Taking WiMAX system as an example, in WiMAX system, an ASN-GW specifically serves as a base station service node, and a Serving ASN-GW specifically serves as a serving base station service node. The present invention provides three embodiments for managing the information of a terminal exiting idle mode, which will be described in detail as follows.

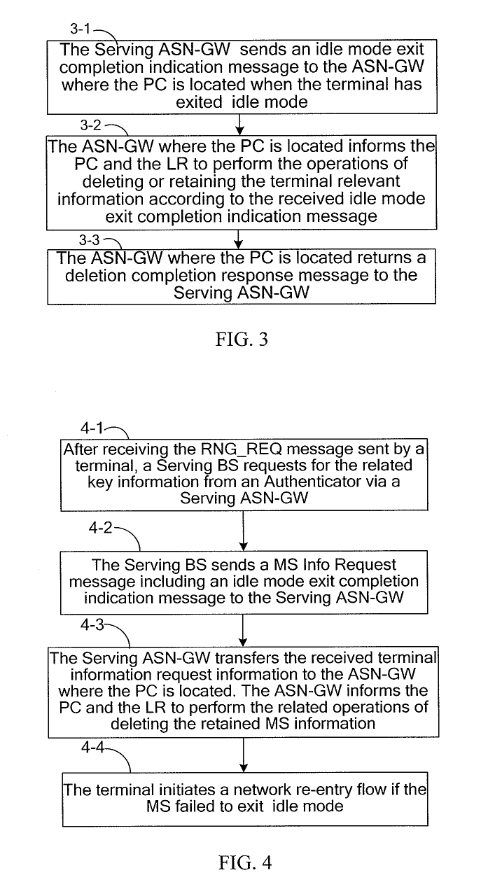

The specific processing flow of embodiment 1 is shown as FIG. 3 including the following blocks.

Block 3-1: A Serving ASN-GW sends an idle mode exit completion indication message to the ASN-GW where the PC is located when the terminal has exited idle mode.

In the specific processing flow shown in FIG. 2, when the Serving ASN-GW has received the establishment confirmation message of data path, the Serving ASN-GW gets to know that the terminal has successfully exited idle mode and succeeds in network re-entry. On one hand, the Serving ASN-GW sends an R4 link establishment success confirmation message to the anchor ASN-GW; on the other hand, the Serving ASN-GW sends an idle mode exit completion indication message to the ASN-GW where the PC of the terminal is located.

Block 3-2: The ASN-GW where the PC is located informs the PC and the LR to perform the operations of deleting or retaining the terminal relevant information according to the received idle mode exit completion indication message.

Specifically, the ASN-GW where the PC serving for the terminal is located deletes the paging state machine which is retained in the PC and is related to the terminal which has exited idle mode after receiving the idle mode exit completion indication message, i.e. instructs PC to stop the relevant paging state machine corresponding the MS and stop sending the MOB_PAG_ADV message or periodicity location updating message to the MS in the follow-up process when the paging interval of the MS arrives. The ASN-GW also informs the LR to delete the relevant information of the MS retained in the LR.

Block 3-3: The ASN-GW where the PC is located returns a response message to the Serving ASN-GW.

Namely, when the PC and the LR complete the related operations of deleting and stopping, the ASN-GW where PC is located sends an idle mode exit completion Ack message indicating the completion of deleting the relevant information of the MS.

If the Serving ASN-GW fails to receive the idle mode exit completion response message, the Serving ASN-GW may continue to resend the idle mode exit completion indication message to the ASN-GW where the PC is located to request the PC and the LR to delete the information of the MS retained in the PC and the LR.

The specific processing flow of Embodiment 2 is shown as FIG. 4, including the following blocks.

Block 4-1: After receiving the RNG_REQ message sent by a terminal, a Serving BS requests for the related key information from an Authenticator via a Serving ASN-GW.

The key information related to the terminal will be stored in the Authenticator if the PC and the Authenticator do not stay in the same physical entity in specific practice. After receiving the RNG_REQ message sent by the terminal, the Serving BS firstly requests for the relevant key information to the Authenticator via the Serving ASN-GW, then verifies the RNG_REQ message according to the acquired key information, and sends an MS Info Request message to the Serving ASN-GW only when the verification is passed.

Block 4-2: The Serving BS sends an MS Info Request message including an idle mode exit completion indication message to the Serving ASN-GW.

Namely, an idle mode exit completion indication message is added into the MS Info Request message sent by the Serving BS to the Serving ASN-GW. The idle mode exit completion indication message may indicate the PC and the LR to delete the relevant information of the MS retained in the PC and the LR.

Block 4-3: The Serving ASN-GW transfers the received terminal information request information to the ASN-GW where the PC is located. The ASN-GW informs the PC and the LR to perform the related operations of deleting the retained MS information.

The Block 4-3 is specifically as follows.

Firstly, according to the received MS Info Request message, the Serving ASN-GW confirms the ASN-GW where the PC is located and sends the MS Info Request message carrying the idle exit completion indication message.

Then, after receiving the MS Info Request message, the ASN-GW where the PC is located needs to return the MS Info Response (MS information response) to the Serving ASN-GW; furthermore, the ASN-GW needs to inform the PC and the LR to delete the relevant information of the MS retained in the PC and the LR, namely, informs the PC to stop the relevant paging state machine of the MS and stop sending the MOB_PAG_ADV message or periodicity location updating message to the MS in the follow-up process when the paging interval of the MS arrives. The ASN-GW also informs the LR to delete the relevant information of the MS retained in the LR. After finishing the deleting operation, the PC may further return a response message to the ASN-GW.

Block 4-4: The terminal initiates a network re-entry flow if the MS failed to exit idle mode.

The specific processing flow of Embodiment 3 is shown as FIG. 5, including the following blocks.

Block 5-1: A timer is configured and started in the PC after the terminal has exited idle mode.

Specifically, the processing flow shown in FIG. 2, the terminal does not initiatively send a deletion request message to the ASN-GW where the PC is located when the terminal has exited idle mode. The PC itself configures and starts a timer. The duration of the timer is determined according to the location updating interval of the MS.

Block 5-2: The relevant operation of deleting the retained terminal information is performed when the location updating message of the terminal is not received after the timer is timeout.

The PC stops the relevant paging state machine aiming at the MS and stops sending the MOB_PAG_ADV message to the MS when the paging interval of the MS arrives in the followed step.

Before the timer is timeout, the PC sends the MOB_PAG_ADV (paging broadcast) message to the MS to request the terminal to perform the location updating and returns the location updating message. When the timer is timeout, the PC stops by itself if the PC has not received the periodicity location updating message sent by the MS and informs the LR to delete the relevant information of the MS retained in the LR. The timer stops if the location updating message initiated by the terminal is received before the timer is timeout and the paging state machine aiming at the terminal is restarted back to the normal idle status.

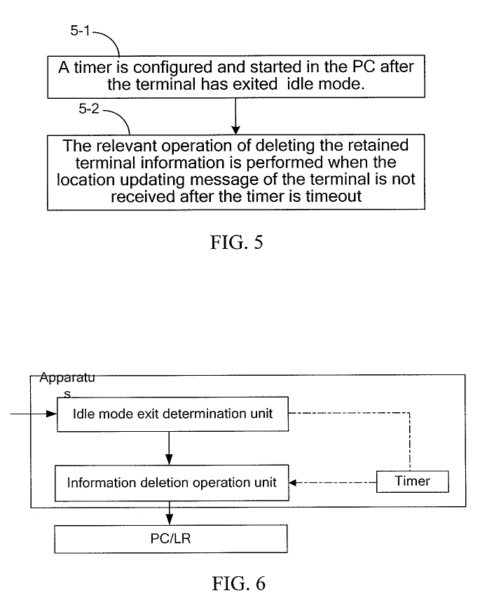

The present invention also provides an apparatus for managing the information of a terminal exiting idle mode. The specific implementation structure of the apparatus is shown as FIG.6, including an idle mode exit determination unit and an information deletion operation unit.

(1) The idle mode exit determination unit is adapted to determinate whether the terminal has exited idle mode and to trigger the information deletion operation unit after determining that the terminal has exited idle mode.

The implementation style for determining whether the terminal has exited idle mode adopted by the unit has been described in above-mentioned embodiments which will not be discussed again.

(2) The information deletion operation unit is adapted to control the deletion of the relevant information of the terminal retained in the paging controller and the location register under the triggering of the idle mode exit determination unit.

Besides, the information deletion operation unit is set in the paging controller and the location register, specifically adapted for the paging controller and the location register to stop the paging state machine corresponding to the terminal and delete the relevant information of the terminal retained in the paging controller and the location register according to the received indication information of requesting to delete the relevant information of the terminal retained in the paging controller and the location register.

The indication message is sent by the serving base station service node to the base station service node where the paging controller providing service for the terminal is located after determining that the terminal has exited idle mode.

The apparatus of the present invention may further include a timer which is configured and started in the paging controller when the terminal has exited idle mode. After the timer is timeout, the information deletion operation unit is triggered if the location updating message of the terminal is not received.

Though illustration and description of the present disclosure have been given in conjunction with the exemplary embodiments thereof, it should be appreciated by persons of ordinary skill in the art that various changes in forms and details can be made without deviation from the spirit and scope of this disclosure, which are defined by the appended claims.

What is claimed is:

1. A method for managing information of a terminal exiting idle mode, comprising:
deleting relevant information of a terminal retained in a paging controller and a location register of a wireless communication system after the terminal has exited an idle mode.

2. The method according to claim 1, further comprising:
deleting, by the paging controller and the location register, the relevant information of the terminal retained in the paging controller and the location register according to received indication information of requesting to delete the relevant information of the terminal retained in the paging controller and the location register, after the terminal has exited idle mode.

3. The method according to claim 2, further comprising:
sending, by a serving base station service node, an indication message to a base station service node where the paging controller providing service for the terminal is located after the terminal has exited idle mode
informing, by the base station service node where the paging controller is located, the paging controller to stop the paging state machine corresponding to the terminal, and the location register to delete the relevant information of the terminal retained in the location register after receiving the indication message.

4. The method according to claim 3, further comprising:
after the paging controller has stopped the paging state machine corresponding to the terminal, not sending a paging message or a message of requesting to perform periodicity location updating when a follow-up paging interval of the terminal arrives.

5. The method according to claim 3, further comprising:
returning, by the base station service node where the paging controller is located, a response message to the serving base station service node after the paging controller and the location register have deleted the relevant information of the terminal retained in the paging controller and the location register.

6. The method according to claim 2, further comprising:
requesting, by the serving base station, for a relevant key information from an authenticator via the serving base station service node; and verifying a received ranging request message after the serving base station has received the searching access request message sent by the terminal;
sending, by the serving base station, a terminal information request message carrying an idle mode exit indication to the serving base station service node after the verification for the ranging request message is passed; and
transferring, by the serving base station service node, the received terminal information request message to a base station service node where the paging controller providing service for the terminal is located; informing, by the base station service node, the paging controller to stop the paging state machine corresponding to the terminal; and informing the location register to delete the relevant information of the terminal retained in the location register.

7. The method according to claim 6, further comprising:
initiating a network re-entry process if the terminal fails to exit idle mode.

8. The method according to claim 1, further comprising:
configuring and starting a timer in the paging controller whose duration is determined by the location updating time interval of the terminal, after the terminal has exited idle mode; and
stopping, by the paging controller, the paging state machine corresponding to the terminal; and informing, by the paging controller, the location register to delete the relevant information of the terminal retained in the location register when the location updating message of the terminal is not received after the timer is timeout.

9. An apparatus for managing information of a terminal exiting idle mode, comprising an idle mode exit determination unit and an information deletion operation unit, wherein:
the idle mode exit determination unit is adapted to determine whether the terminal has exited idle mode, and to trigger the information deletion operation unit after determining that the terminal has exited idle mode; and
the information deletion operation unit is adapted to control the deletion of the relevant information of the terminal retained in the paging controller and the location register under the triggering of the idle mode exit determination unit.

10. The apparatus according to claim 9, wherein the information deletion operation unit, set in the paging controller and the location register, is specifically adapted to stop the paging state machine corresponding to the terminal and delete the relevant information of the terminal retained in the paging controller and the location register according to the received indication information of requesting to delete the relevant information of the terminal retained in the paging controller and the location register after the terminal has exited idle mode.

11. The apparatus according to claim 9, wherein the indication message is sent by the serving base station node to the base service node where the paging controller providing service for the terminal is located after determining that the terminal has exited idle mode.

12. The apparatus according to claim 9, further comprising:
a timer, configured and started in the paging controller after the terminal has exited idle mode; and adapted to trigger the information deletion operation unit when the location updating message of the terminal is not received after the timer is timeout.

13. The apparatus according to claim 10, further comprising:
a timer, configured and started in the paging controller after the terminal has exited idle mode; and adapted to trigger the information deletion operation unit when the location updating message of the terminal is not received after the timer is timeout.

14. The apparatus according to claim 11, further comprising:
a timer, configured and started in the paging controller after the terminal has exited idle mode; and adapted to trigger the information deletion operation unit when the location updating message of the terminal is not received after the timer is timeout.
